(19) United States
(12) Patent Application Publication
(10) Pub. No.: US 2024/0290027 A1
(43) Pub. Date: Aug. 29, 2024

(54) Synthetic Images for Machine Learning

(71) Applicants: Hewlett-Packard Development Company, L.P., Spring, TX (US); Purdue Research Foundation, West Lafayette, IN (US)

(72) Inventors: Fan Bu, Palo Alto, CA (US); Tianqi Guo, Palo Alto, CA (US); Qian Lin, Palo Alto, CA (US); Jan Philip Allebach, West Lafayette, IN (US)

(21) Appl. No.: 18/571,687

(22) PCT Filed: Jun. 30, 2021
(86) PCT No.: PCT/US2021/039865

§ 371 Date: Dec. 18, 2023

(51) Int. Cl. G06T 15/00; G06T 5/70; G06T 7/00; G06V 10/774; G06V 20/70

(52) U.S. Cl. CPC G06T 15/00; G06T 5/70; G06T 7/0002; G06V 10/774; G06V 20/70; G06T 2207/20081; G06T 2210/12

(57) ABSTRACT

In one example in accordance with the present disclosure, an electronic device is described. An example electronic device includes a processor and memory storing executable instructions that when executed cause the processor to generate multiple synthetic images of an object based on defined object parameters and randomized visual parameters. The instructions also cause the processor to generate annotations of the object in multiple synthetic images based on the defined object parameters and the randomized visual parameters. The instructions further cause the processor to train a machine-learning (ML) model for detecting the object using the multiple synthetic images and annotations.

### BACKGROUND

Electronic technology has advanced to become virtually ubiquitous in society and has been used to enhance many activities in society. For example, electronic devices are used to perform a variety of tasks, including work activities, communication, research, and entertainment. Different varieties of electronic circuits may be utilized to provide different varieties of electronic technology.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of an electronic device to generate synthetic images and annotations for object detection, according to an example.

FIG. 2A illustrates a synthetic image, according to an example.

FIG. 2B illustrates annotations for a synthetic image, according to an example.

FIG. 3 is a flow diagram illustrating a method for machine-learning (ML) model-based object detection, according to an example.

FIG. 4 is a flow diagram illustrating a method for generating synthetic images and annotations, according to an example.

FIG. 5 illustrates an exploded view of a simulated object for use in ML model-based object detection, according to an example.

FIG. 6 illustrates an assembled view of a simulated object for use in ML model-based object detection, according to an example.

FIG. 7 is a flow diagram illustrating a method for ML model-based object detection, according to an example.

FIG. 8 is a flow diagram illustrating a method for defect detection using the results of ML model-based object detection, according to an example.

FIG. 9 depicts a non-transitory machine-readable storage medium for generating synthetic images and annotations, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Electronic devices may include memory resources and processing resources to perform computing tasks. For example, memory resources may include volatile memory (e.g., random access memory (RAM)) and non-volatile memory (e.g., read-only memory (ROM), data storage devices (e.g., hard drives, solid-state devices (SSDs), etc.) to store data and instructions. In some examples, processing resources may include circuitry to execute instructions. Examples of processing resources include a central processing unit (CPU), a graphics processing unit (GPU), or other hardware device that executes instructions, such as an application specific integrated circuit (ASIC).

An electronic device may be a device that includes electronic circuitry. For instance, an electronic device may include integrated circuitry (e.g., transistors, digital logic, semiconductor technology, etc.). Examples of electronic devices include computing devices, workstations, servers, laptop computers, desktop computers, smartphones, tablet devices, wireless communication devices, game consoles, game controllers, smart appliances, printing devices, vehicles with electronic components, aircraft, drones, robots, smart appliances, etc.

In some examples, electronic devices may be used for object detection. In some examples of object recognition, an image may be captured by a camera and an object may be detected in the image. In some examples, artificial intelligence techniques may be used to perform object detection. For example, a machine-learning (ML) model (also referred to as deep learning) may be trained to detect objects in images.

ML model-based approaches may use many (e.g., hundreds or thousands) of examples per object type for training. For example, for a given object, hundreds or thousands of training images may be used to train an ML model to detect the object in the images. Furthermore, the object may be annotated in each image. In some examples, these annotations may include an object description (e.g., object name, object type, shape type), a bounding box, a segmentation mask, or a combination thereof. Therefore, it may be time consuming and expensive to produce training datasets to train ML learning models for custom object types, such as industrial parts. For example, numerous pictures may be taken with the object in different positions, orientations, settings, etc. Then, each of the pictures are annotated. As seen by this example, the annotation process may be especially time consuming when pixel-wise detection (e.g., segmentation masks) is desired, as the object contour has to be carefully drawn.

To avoid the difficulty, time and expense of generating training image datasets, the examples described herein generate photorealistic training images using computer graphics rendering techniques. The described examples are able to automatically generate training data for object detection in a short amount of time on an electronic device.

As mentioned, ML-based techniques use a large amount of training data to train an ML model. However, in many scenarios, acquiring the training data is time-consuming. In these scenarios, synthetic data generation can be employed to generate the data for training. In some approaches, synthetic data may be formed from 3D rendering engines. However, many of these approaches do not perform randomization in features in the 3D environment (e.g., illumination, context, background objects, etc.) and randomization in the object of interest (e.g., textures, 6-Degree of freedom pose, camera position, etc.). This variability in the data generation may be used to train ML models to be more robust for detecting objects in the real world.

The examples described herein provide a framework to train a machine learning-based computer vision system for object detection and segmentation, using synthetically rendered images. To train the machine learning models, an automated process may be used to generate the training dataset. In some examples, this process may be applied to generate a training dataset for geometric shapes. The synthetic image training dataset may be applied to many implementations in artificial intelligence, such as package defect detection.

In some aspects, photorealistic images may be synthesized using a 3D rendering engine. In some examples, the synthetic images may include foreground objects of randomized dimensions, textures, and positions rendered on randomly transformed backgrounds. In some examples, techniques to ensure photorealism may include simulation of non-uniform illumination, out-of-focus effects of camera lens, motion blurring, shadows cast by objects, and the addition of different kinds of noise. The type of shape, bounding box, and an instance-wise segmentation mask of each object may be output from the 3D rendering engine as training targets for a machine-learning (ML) model. In some examples, an ML model may include a neural network (e.g., convolutional neural networks). The trained ML model may be applied to real-world images captured by a camera to identify general shapes present in the images.

The described examples are robust to various visual conditions. Furthermore, the described examples may obviate manual annotation of datasets and network training for a specific application. Consequently, the described examples can be applied to different vision tasks with minimal human input.

The present specification describes examples of an electronic device. The electronic device includes a processor and memory storing instructions that cause the processor to generate multiple synthetic images of an object based on defined object parameters and randomized visual parameters. The instructions also cause the processor to generate annotations of the object in multiple synthetic images based on the defined object parameters and the randomized visual parameters. The instructions further cause the processor to train an ML model for detecting the object using the multiple synthetic images and annotations.

In another example, the present specification also describes a non-transitory machine-readable storage medium that includes instructions, when executed by a processor of an electronic device, cause the processor to generate multiple synthetic images of multiple objects based on shape types of the multiple objects and randomized parameters applied to the multiple objects. The instructions also cause the processor to generate annotations for the multiple objects in the multiple synthetic images based on the shape types and the randomized parameters. The instructions further cause the processor to train an ML model for detecting the multiple objects using the multiple synthetic images and annotations.

In yet another example, the present specification also describes a method that includes generating a simulated object from a number of simulated subcomponents. The method also includes generating multiple synthetic images of the simulated object based on randomized visual parameters. The method further includes generating annotations for the multiple synthetic images based on information from the number of simulated subcomponents and randomized visual parameters. The method additionally includes training an ML model to detect an observed object and subcomponents in images captured by a camera using the multiple synthetic images and annotations.

As used in the present specification and in the appended claims, the term “processor” may be a processor resource, a controller, an application-specific integrated circuit (ASIC), a semiconductor-based microprocessor, a central processing unit (CPU), and a field-programmable gate array (FPGA), and/or other hardware device that executes instructions.

As used in the present specification and in the appended claims, the term “memory” may include a computer-readable storage medium, which computer-readable storage medium may contain, or store computer-usable program code for use by or in connection with an instruction execution system, apparatus, or device. The memory may take many types of memory including volatile memory (e.g., RAM) and non-volatile memory (e.g., ROM).

As used in the present specification and in the appended claims, the term “data storage device” may include a non-volatile computer-readable storage medium. Examples of the data storage device include hard disk drives, solid-state drives, writable optical memory disks, magnetic disks, among others. The executable instructions may, when executed by the respective component, cause the component to implement the functionality described herein.

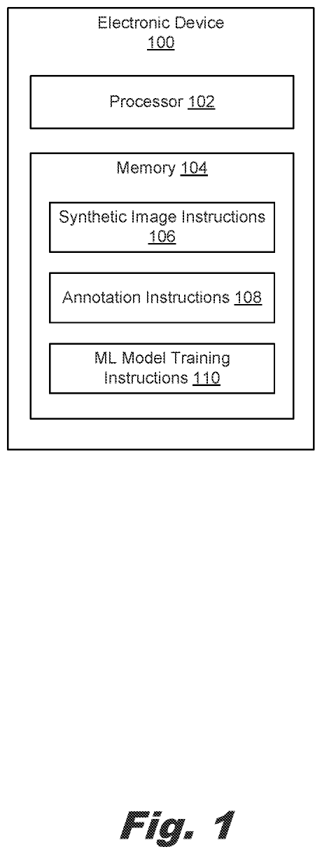

Turning now to the figures, FIG. 1 is a block diagram of an electronic device 100 to generate synthetic images and annotations for object detection, according to an example. As used herein, examples of an electronic device 100 may include computing devices, workstations, servers, laptop computers, desktop computers, smartphones, tablet devices, wireless communication devices, game consoles, game controllers, smart appliances, printing devices, vehicles with electronic components, aircraft, drones, robots, smart appliances, or other devices having memory resources and processing resources.

As described above, the electronic device 100 includes a processor 102. The processor 102 of the electronic device 100 may be implemented as dedicated hardware circuitry or a virtualized logical processor. The dedicated hardware circuitry may be implemented as a central processing unit (CPU). A dedicated hardware CPU may be implemented as a single to many-core general purpose processor. A dedicated hardware CPU may also be implemented as a multi-chip solution, where more than one CPU are linked through a bus and schedule processing tasks across the more than one CPU.

A virtualized logical processor may be implemented across a distributed computing environment. A virtualized logical processor may not have a dedicated piece of hardware supporting it. Instead, the virtualized logical processor may have a pool of resources supporting the task for which it was provisioned. In this implementation, the virtualized logical processor may be executed on hardware circuitry; however, the hardware circuitry is not dedicated. The hardware circuitry may be in a shared environment where utilization is time sliced. Virtual machines (VMs) may be implementations of virtualized logical processors.

In some examples, a memory 104 may be implemented in the electronic device 100. The memory 104 may be dedicated hardware circuitry to host instructions for the processor 102 to execute. In another implementation, the memory 104 may be virtualized logical memory. Analogous to the processor 102, dedicated hardware circuitry may be implemented with dynamic random-access memory (DRAM) or other hardware implementations for storing processor instructions. Additionally, the virtualized logical memory may be implemented in an abstraction layer which allows the instructions to be executed on a virtualized logical processor, independent of any dedicated hardware implementation.

The electronic device 100 may also include instructions. The instructions may be implemented in a platform specific language that the processor 102 may decode and execute. The instructions may be stored in the memory 104 during execution. In some examples, the instructions may include synthetic image instructions 106, annotation instructions 108, and ML training instructions 110, according to the examples described herein.

As described above, there are scenarios where the training dataset acquisition and preparation is costly or impractical. For example, to train an ML model for object detection, a training dataset may include many (e.g., thousands) of different images where each image is annotated with training information (e.g., object type, object bounding box, object segmentation mask, etc.). In such scenarios, the described examples of synthetic image generation may be employed to create training data for an ML model.

In some examples, synthetic images may be generated data using a 3D rendering engine (e.g., BLENDER, UNITY, MAYA, UNREAL ENGINE etc.). These 3D rendering engines may provide a set of tools that can be used to create realistic images that can be used to generate synthetic images.

The described examples enhance the performance of 3D rendering engines. For example, these examples provide for generating multiple virtual spaces with multiple textured objects and lighting variations. These examples may also mitigate the domain shift between the synthetic images and the real images.

In some examples, the processor 102 may execute the synthetic image instructions 106 to cause the processor 102 to generate multiple synthetic images of an object based on defined object parameters and randomized visual parameters. In some examples, the object may include a geometric shape. For example, the object may be a circle, ellipse, or polygon (e.g., triangle, square, rectangle, pentagon, hexagon, etc.).

In some examples, the processor 102 may execute the synthetic image instructions 106 to cause the processor 102 to generate multiple synthetic images of the object based on defined object parameters. In some examples, the defined object parameters may define an object type. For example, the defined object parameters may specify that an object in the synthetic images is to be a geometric shape. In some examples, the defined object parameters may include data that is saved in memory 104. In some examples, the defined object parameters may be received from a user. For example, a user may indicate an object type (e.g., geometric shape) for use in generating the synthetic images.

In some examples, the defined object parameters may include multiple object types. For instance, the defined object parameters may define different geometric shapes for use in generating the synthetic images. Therefore, in some examples, the defined object parameters may include a list of different object types. For example, the defined object parameters may include a first geometric shape (e.g., an ellipse), a second geometric shape (e.g., a polygon), and so forth.

In some examples, the defined object parameters may include dimensions of an object. For example, the defined object parameters may provide two-dimensional (2D) or three-dimensional (3D) measurements for an object. In an example for a circle, the defined object parameters may include a radius or diameter for the circle. In an example for an ellipse, the defined object parameters may include focal points and eccentricity of the ellipse. In yet another example for a polygon, the defined object parameters may include defined dimensions for sides or vertices of the polygon.

In some examples, the defined object parameters may be provided to a 3D rendering engine. For example, the processor 102 may cause the 3D rendering engine may load the defined object parameters. In some examples, the defined object parameters may be provided to the 3D rendering engine via an application programming interface (API).

In some examples, the synthetic image instructions 106 may cause the processor 102 to generate multiple synthetic images of the object further based on randomized visual parameters. For example, the processor 102 may randomize visual parameters that are applied to the synthetic images. In some examples, the processor 102 may provide the randomized visual parameters to the 3D rendering engine. The randomized visual parameters may include instructions for adjusting the visual appearance of the synthetic images. In some examples, the randomized visual parameters may be provided to the 3D rendering engine via the API. The API may allow for varying the visual parameters in synthetic images without manual intervention by a user.

In some examples, the randomized visual parameters may include lighting (i.e., illumination), object pose, object orientation, background image and other visual aspects. Some examples of randomized visual parameters are now described in more detail.

In some examples, a randomized visual parameter may include the background of a given synthetic image. For example, the processor 102 may randomly select a background image from a library of images. In some examples, the processor 102 may randomly augment the selected background image. For instance, the processor 102 may randomly adjust the scaling, rotation, and/or cropping of the background image. In some examples, high-resolution images may be collected from a public domain library as the rendered background. These images may include, but are not limited to, real-world photography, scans of painting artworks, computer-rendered artworks, general textures, and solid colors. For rendering a given synthetic image, one background image may be randomly selected, then arbitrarily scaled, flipped, rotated, and cropped as the background.

In some examples, a randomized visual parameter may include a manipulation of an object defined by the defined object parameters. Some examples of these randomized visual parameters include selecting random object types, random object positions, random object orientation, random object dimensions and random object textures. These randomized object properties may be applied to a given synthetic image. In some examples, the object position may be a location that an object is placed within a given synthetic image. In some examples, the processor 102 may randomly select different locations for placing the object in the given synthetic image. For example, for each of the synthetic images, the processor 102 may randomly select a different location for placing objects. In some examples, a 2D orientation or 3D orientation of the object may be randomly selected by the processor 102.

As described above, the surface texture of an object may be randomly selected and applied to an object in a given synthetic image. In some examples, surface texture images may be collected from a library (e.g., a public domain texture image database). Those texture images may include different types of textures such as metal, cardboard, glass, paper, granite, sand, and plastic of different colors, etc. For each object, one texture image may be randomly selected, then scaled, flipped, and rotated arbitrarily before being appended to the object surface. For each of the synthetic images, the processor 102 may randomly select different textures for the objects in the synthetic images.

In an example where the defined object parameters include polygons and ellipses, thin plates of polygons and ellipses of random dimensions may be placed at random 3D positions over the background image. In some examples, the surface normal directions of the objects (e.g., polygons and ellipses) may be parallel to the optical axis of the camera lens, but rotated by an arbitrary angle. Each rendered synthetic image may include a random number of objects (e.g., polygons and ellipses). In some examples, synthetic images with fewer objects may help the ML model to learn the full shapes of each category, while images with more objects may help the ML model to learn occlusion and partial shapes, which may occur in real-world images.

In some examples, a randomized visual parameter may include the lighting of the synthetic images. Some examples of randomized lighting parameters include random lighting positions, random lighting orientation, and random lighting intensity. For example, light sources of different types (e.g., point light, parallel light, etc.) may be randomly selected for illumination of a given synthetic image. For example, to allow uneven illumination and to mimic partially lit scenes, a spotlight with a random cone angle may be placed at a random 3D position, while facing towards the objects and pointing to a random direction. For each rendered synthetic image, the power (e.g., intensity) of the light source may also be randomly varied to ensure the ML model is robust to lighting conditions.

In an aspect of the randomly generated lighting of the synthetic images, shadows may be generated. As objects are placed randomly at different heights, higher objects may cast shadows on lower objects when overlapping occurs. To allow shadows under non-overlapping objects, a transparent, texture-less, infinitely-large plane may be placed at a random height below all the objects. For example, a shadow catcher plane may be implemented in the 3D rendering engine. This shadow catcher plane may become visible by collecting the shadows from other objects. Therefore, the processor 102 may simulate shadows cast on the multiple objects in the synthetic images. Each of the synthetic images may include randomized shadows cast on the multiple objects.

In some examples, a randomized visual parameter may include manipulating camera properties for the synthetic images. Some examples of randomized camera properties include random focal length of the virtual camera and aperture area used by the 3D rendering engine to generate the synthetic images. In some examples, for each synthetic image, two rendering passes may be performed: one for a photorealistic image, and one for an instance-wise segmentation mask. For rendering the photorealistic image, the focal length and aperture area (also referred to as f-stop) on the virtual camera may be varied randomly within ranges. By randomly selecting focal length and aperture area, a blurring effect (e.g., out-of-focus) may be simulated in a given synthetic image. Therefore, the processor 102 may cause the 3D rendering engine to add randomized out-of-focus effects of a camera lens to the synthetic images.

In some examples, a randomized visual parameter may include adding simulated noise or motion to the synthetic images. In some examples, the processor 102 may cause the 3D rendering engine to simulate motion blurring in the synthetic images, where each of the synthetic images to include different randomized motion blurring. In some examples, after rendering of the synthetic image, manipulation of the synthetic image may be performed to simulate motion blurring and image noise. To simulate directional motion blurring of the objects, the rendered synthetic image may be convolved with a normalized filter whose elements are non-zero along a randomly-angled straight line. The size of the filter may be varied within a fixed range (e.g., from 5 pixels to 30 pixels) to allow simulation of various motion displacements while the camera shutter is open. For example, a filter to mimic the blurring effect of an object undergoing a 5-pixel displacement along the 45° direction may have the following format:

$$[ \begin{matrix}0.2 & 0 & 0 & 0 & 0 \\ 0 & 0.2 & 0 & 0 & 0 \\ 0 & 0 & 0.2 & 0 & 0 \\ 0 & 0 & 0 & 0.2 & 0 \\ 0 & 0 & 0 & 0 & 0.2\end{matrix} ] .$$

In some examples, the processor 102 may add noise to the synthetic images. Each of the synthetic images may include a randomized type of noise. Noise of different types may be randomly introduced into the synthetic images. Some examples of noise types are described in Table 1.

TABLE 1

| Noise Type | Simulated Source |
|---|---|
| Gaussian | Thermal vibration of atoms on sensor or amplifier |
| Salt-and-pepper | Malfunctioning pixels, faulty memory, errors in |
| | digitization or transmission, etc. |
| Poisson | Random fluctuation of photons from light source |
| Speckle | Multiplicative noise in coherent imaging system |

In some examples, the noise may be randomly selected and added to the synthetic images during imaging, digitization, storage, or transmission stages. In some examples, the noise may be simulated with random parameters (e.g. mean and variance for Gaussian) by an image processing engine. In some examples, the image processing engine may be instructed to apply the random noise parameters using a script (e.g., a Python script). The introduced noise during training may help the ML model to be more robust when working with real-world images, which may include noise from random sources.

In some examples, the processor 102 may generate multiple synthetic images 102 of the objects included in the defined object parameters by applying the randomized visual parameters. For example, the processor 102 may load the object types included in the defined object parameters into the 3D rendering engine. The processor 102 may then cause the 3D rendering engine to randomly apply the randomized visual parameters as described above. Each synthetic image may have a different set of randomized visual parameters. Therefore, the synthetic images may include images that are rendered with different randomized visual parameters. The multiple synthetic images generated by the 3D rendering engine may include photorealistic images.

In some examples, the processor 102 may generate a given number of synthetic images. For example, the number of synthetic images that the 3D rendering engine is to render may be specified (e.g., by a user). For example, the user may specify that 3,000 synthetic images are to be generated. In some examples, the number of synthetic images may be determined based on time constraints. For example, generating more synthetic images may produce better training results for the ML model at the expense of processing time. Therefore, a threshold number of synthetic images may be generated to ensure acceptable ML model performance.

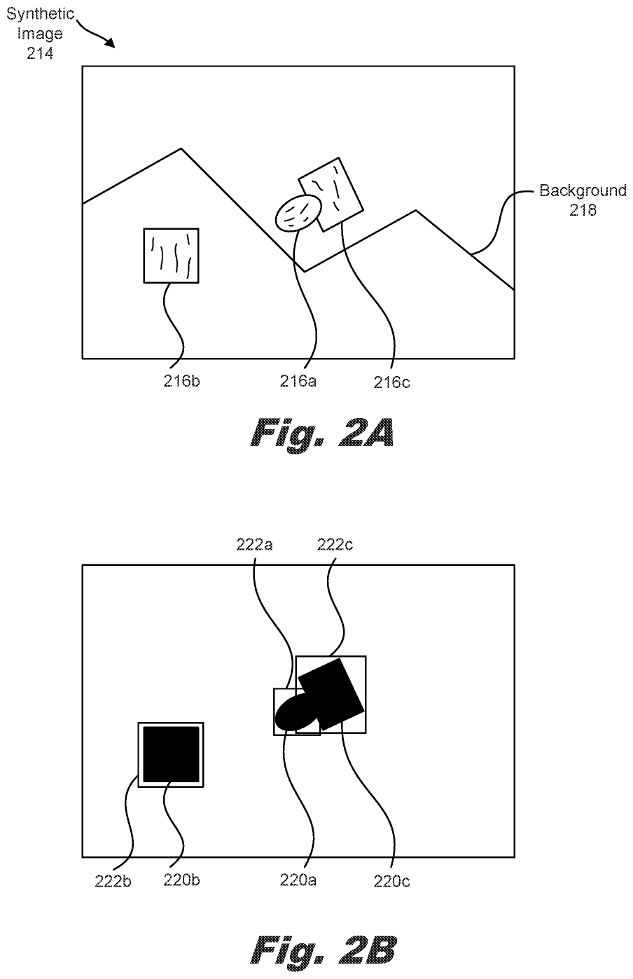

Referring briefly to FIG. 2A, an example of a synthetic image 214 is illustrated. The synthetic image 214 may be generated as described in FIG. 1. In this example, a background 218 is a mountain image. The background 218 is randomly selected from a library of background images. The scaling, rotation, and/or cropping of the background 218 may be randomly adjusted.

A number of objects 216 may be randomly selected from the defined object parameters and placed in the synthetic image 214. For example, a first object 216a may be selected from an ellipse object type. A second object 216b and a third object 216c may be selected from a quadrilateral object type. The orientation of the objects 216a-c may be randomly adjusted in 3D space. The location and dimensions of the objects 216a-c in the synthetic image 214 may be randomly selected.

In some examples, additional visual effects may be randomly generated in the synthetic image 214. For example, textures may be randomly applied to the objects 216a-c. In some examples, the position, orientation and intensity of a lighting source may be randomly determined. The camera focal length and aperture area may be randomly assigned. The random motion blur and random noise may be simulated.

Returning again to FIG. 1, in some examples, the processor 102 may execute the annotation instructions 108 to cause the processor 102 to generate annotations of the object in multiple synthetic images based on the defined object parameters and the randomized visual parameters. For example, the annotations may be ground truth information used to train the ML model about the objects within the synthetic images. Because the synthetic images are generated using the defined object parameters and the randomized visual parameters, the processor 102 may use information from the defined object parameters and the randomized visual parameters to generate the annotations without human input.

In some examples, the annotations may include an object type. In some examples, the processor 102 may record the shape type for each of the objects in the synthetic images. For example, the object type may be obtained from the defined object parameters. In some examples, the object type may be a type of geometric shape (e.g., circle, ellipse, polygon, etc.).

In some examples, a list of objects included in each synthetic image may be generated. For example, for a given synthetic image, the processor 102 may generate an object list that includes the shape types for each of the objects included in the given synthetic image. In some examples, the processor 102 may also include positions and dimensions of the objects in the object list.

In some examples, the annotations may include a bounding box. For example, the processor 102 may determine the bounding box for each object in a given synthetic image using the object list. For each object in given synthetic image, the processor 102 may identify a bounding box to surround a given object using the known positions and dimensions of the given object. Therefore, the processor 102 may determine a bounding box for each of the multiple objects in each of the multiple synthetic images.

In some examples, the annotations may include a segmentation mask (also referred to as a segmentation map) of the object in a given synthetic image. In some examples, a segmentation mask may include the contour (e.g., polygon) of an object in a synthetic image. The segmentation mask may define the contour of an object. The segmentation mask may differentiate what is included as the object and other areas of the synthetic image that are not part of the object.

As described above, for each synthetic image, two rendering passes may be performed: one for a photorealistic synthetic image, and one for an instance-wise segmentation mask. Therefore, a 3D rendering engine may generate a synthetic image in a first rendering pass and a segmentation mask in a second rendering pass. For the ground truth segmentation mask, the focal length and aperture area on the camera may be fixed such that all the objects are in focus, and such that the boundaries of the objects in the texture-less segmentation mask are sharp.

In some examples, the annotations may be saved. For example, the bounding box, object type and segmentation mask for a given synthetic image may be saved and associated with the given synthetic image. In some examples, the annotations may be saved as a file (e.g., a JSON file) or metadata of a given synthetic image.

Referring briefly to FIG. 2B, an example of annotations for a synthetic image 214 are illustrated. In this example, annotations for the synthetic image 214 of FIG. 2A are described. For example, a segmentation mask 220a and a bounding box 222a may be generated for the first object 216a. A segmentation mask 220b and a bounding box 222b may be generated for the second object 216b. A segmentation mask 220c and a bounding box 222c may be generated for the third object 216c.

In some examples, the annotations of FIG. 2B may also include a list of object types. In this case, the object types may include the shape type of the objects 216a-c. For example, the first object 216a may have a shape type of ellipse. The second object 216b and the third object 216c may have a shape type of quadrilateral.

Referring again to FIG. 1, in some examples, the processor 102 may execute the ML model training instructions 110 to cause the processor 102 to train an ML model for detecting an object using the multiple synthetic images and annotations. In some examples, the processor 102 may train the ML model for detecting an object in an image captured by a camera based on the multiple synthetic images and annotations. Examples of the ML models that may be used include convolutional neural networks (CNNs) (e.g., basic CNN, R-CNN, Mask R-CNN, inception model, residual neural network, etc.) and recurrent neural networks (RNNs) (e.g., basic RNN, multi-layer RNN, bi-directional RNN, fused RNN, clockwork RNN, etc.). Some approaches may utilize a variant or variants of RNN (e.g., Long Short Term Memory Unit (LSTM), peephole LSTM, no input gate (NIG), no forget gate (NFG), no output gate (NOG), no input activation function (NIAF), no output activation function (NOAF), no peepholes (NP), coupled input and forget gate (CIFG), full gate recurrence (FGR), gated recurrent unit (GRU), etc.). Other examples of neural networks that may be used include Simultaneous Detection and Segmentation (SDS) and YOLO. Different depths (e.g., layers) of a neural network or multiple neural networks may be utilized in accordance with some examples of the techniques described herein.

The synthetic images and annotations may form a dataset for training the ML model. The synthetic images and annotations may be processed by the ML model to learn how to detect the object in the synthetic images. In some examples, the training refers to determining the best set of weights for maximizing the accuracy of the ML model. In some examples, to train the ML model, three types of data may be used: training data, test data, and validation data. The synthetic images may be used for each of the training data, test data, and validation data. For example, a part of the dataset may be reserved to validate the ML model. Before validation, the ML model may be tested with the test dataset.

In some examples, the ML model may perform detection, classification, and segmentation of the objects (e.g., geometric shapes) in images. In some examples, the neural networks for the ML model may include a feature extractor (backbone), a region proposal network, a pixel-wise classification network. In some examples, separate neural networks may be used for each individual task. In some examples, a multi-purpose neural network (e.g., Mask R-CNN) may be used to obtain all three predictions at once. In an example, the ML model may include a 50-layer ResNet backbone, as well as a feature pyramid network (FPN) for recognition of objects of different scales.

Based on pre-trained weights, the ML model may be fine-tuned on a number (e.g., 1000) rendered samples from the synthetic images and annotations. In some examples, the ML model may be trained for a number (e.g., 20) of epochs, where the trained weights are saved for every epoch. The validation accuracy may be calculated by the Intersection Over Union metric (IoU, also referred to as Jaccard similarity index) between the detected area and the ground truth area for all objects in the validation dataset. The ML model with the highest validation accuracy may be chosen as the final ML model.

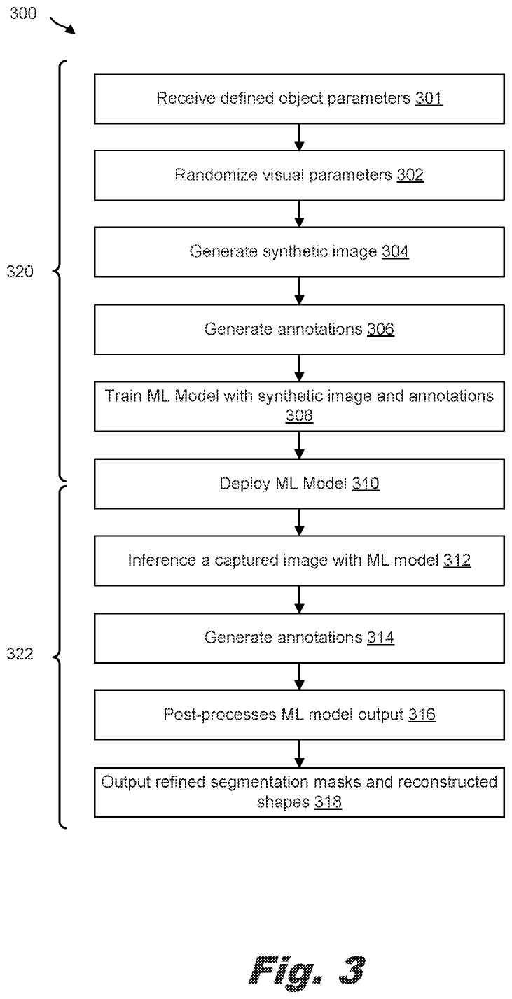

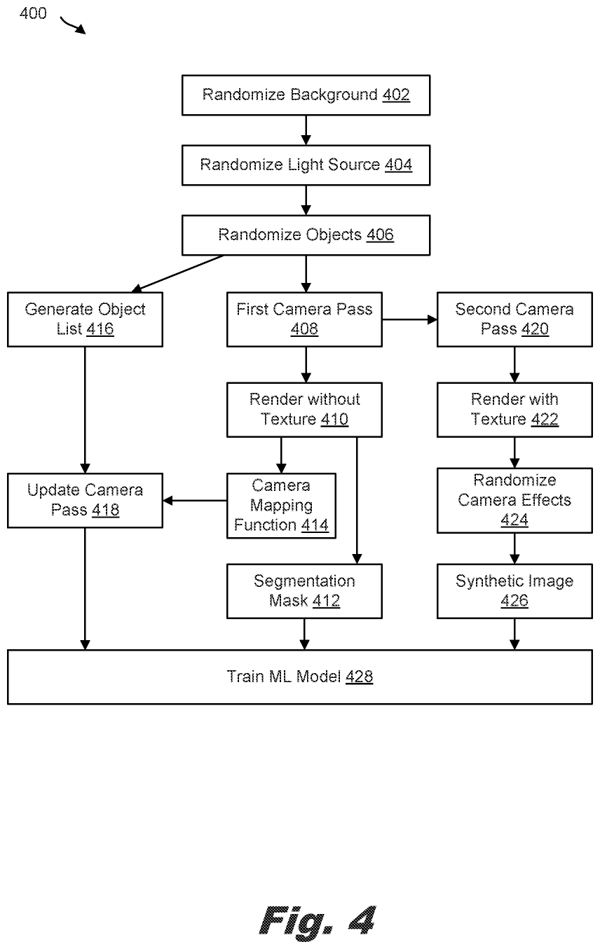

Although the ML model is trained on artificially generated datasets (e.g., the synthetic images and annotations), the ML model is capable of making meaningful predictions with real-world images due to the strong feature extraction and representation power of neural networks (e.g., CNNs). The final output of the trained ML model after inference on a real-world image may include three sets of data: 1) a list of objects that each belongs to a different shape type (e.g. quadrilateral, ellipse, etc.); 2) the coordinates of a bounding box for each object; 3) the instance-wise segmentation mask that marks each pixel of the original image by discrete integers, where each integer corresponds to one detected object. An example of an ML-based object detection is described in FIG. 3. An example of generating a synthetic image and annotations is described in FIG. 4.

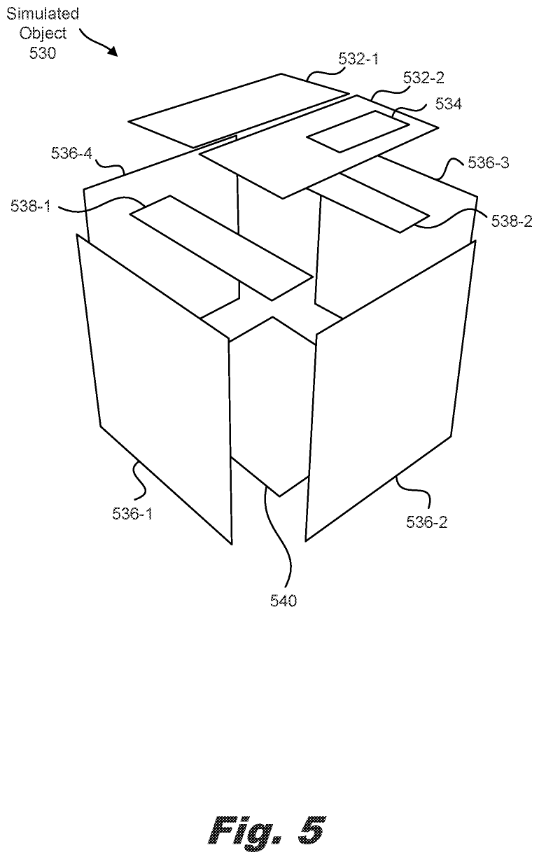

In some examples, the techniques described herein may be used to detect a simulated object formed from a number of simulated subcomponents. For example, when there is prior knowledge about the downstream application for the ML-based object detection described herein, an arrangement of objects (referred to as simulated subcomponents) may be used to form a more complicated object (referred to as a simulated object). For example, two ovals may be placed concentrically to help the ML model to learn the shape of rings if those occur frequently in a test dataset. Similarly, thin plates of rectangles can be assembled as a cardboard box to detect the flaps of a shipping package. An example of this approach is described in FIGS. 5-7.

The examples described herein provide for automated 3D rendering of a large number of photorealistic synthetic images. For example, more than 1,000 sets of training pairs (e.g., synthetic image and annotations) may be automatically generated. The synthetic images may simulate ill-conditioned images with poor lighting, out-of-focus blurring, directional motion blurring, and various types of noise. The ML model may, thus, learn to be robust to those conditions, which otherwise would involve careful selection of template images or extensive hardcoding to deal with those scenarios. Furthermore, with minimal human input, for example to select the detected general shapes of interest from the system output, the described examples are applicable to a wide range of computer vision tasks, without application-specific fine-tuning. This avoids extensive manual annotation of datasets, and thus facilitates the fast deployment of the general shape detection to new tasks.

Some examples of applications of the described approaches include vision-based defect inspection on product lines, where the product of interest can be assembled as special arrangements of the general shapes during 3D rendering. With each individual part being detected from the trained ML model, geometric constraints may be specified between the parts to meet criteria for quality control, and to determine whether each product under inspection passes or fails quality control standards. Because the described ML-based object detector is capable of learning the general representation of each shape, these examples may be deployed in a single ML model for different production lines.

FIG. 3 is a flow diagram illustrating a method 300 for ML model-based object detection, according to an example. In some examples, the method 300 may be performed by a processor, such as the processor 102 of FIG. 1.

In some examples, the method 300 may include an ML model preparation stage 320 and an ML model deployment stage 322. Beginning with the ML model preparation stage 320, at 301, defined object parameters may be received. For example, a number of objects (e.g., geometric shapes) may be defined.

At 302, a number of visual parameters may be randomized. For example, for a given synthetic image, the background, objects, lighting, shadows, camera parameters, simulated motion and simulated noise may be randomized. This may be accomplished as described in FIG. 1.

At 304, a synthetic image may be generated. For example, a 3D rendering engine may apply the randomized visual parameters to the objects defined by the defined object parameters.

At 306, annotations may be generated for the synthetic image. For example, the annotations may include ground truth information determined from the synthetic image and the randomized visual parameters. In some examples, the annotations may include the type of object (e.g., shape type), bounding boxes, and segmentations masks.

At 308, the ML model may be trained using the synthetic images and annotations. Once trained, the ML model may perform object detection. For example, the ML model may be trained to detect geometric shapes in images. At 310, the trained ML model may be deployed.

In the ML model deployment stage 322, the ML model may be used to detect objects (e.g., geometric shapes) in images. For example, at 312, the ML model may perform an inference on a captured image. This may include running the ML model to detect objects in the captured image. At 314, for each object detected in an image, the ML model may output annotations. For example, the ML model may output the type of object (e.g., type of shape), a bounding box, and a segmentation mask.

In some examples, the ML model deployment stage 322 may include post-processing of the ML model output, at 316. For example, the segmentation masks generated by the ML model may be refined. In another example, shapes may be reconstructed from the refined segmentation masks. At 318, the post-processing may output the refined masks and reconstructed shapes.

FIG. 4 is a flow diagram illustrating a method 400 for generating synthetic images and annotations, according to an example. In some examples, the method 400 may be performed by a processor, such as the processor 102 of FIG. 1. In some examples, portions of the method 400 may be performed by different processors.

At 402, a background may be randomized. For example, an image may be randomly selected for the background. The background may be randomly scaled, rotated and cropped.

At 404, a light source may be randomized. For example, the position, orientation, and intensity of the light source may be randomly selected.

At 406, objects may be randomized. For example, a random selection of object types and the number of objects may be performed. The positions, dimensions, orientations, and textures of the objects may be randomly determined.

At 408, a first camera pass may be initiated. For example, in the first pass, a fixed focal length and a fixed aperture area may be set for the first camera pass.

At 410, a first image may be rendered without texture using the fixed focal length and fixed aperture area. At 412, a segmentation mask may be generated for each object in the image. For the ground truth segmentation mask, the focal length and aperture area on the perspective camera are fixed such that all the objects are well in focus, where the boundaries of the objects in the texture-less segmentation mask are sharp. Anchor points may be added to the rendered image. To calibrate the camera mapping function from physical units in world coordinates to pixel units in image coordinates, texture-less anchor disks of known sizes may be placed at fixed physical positions outside the object region.

At 414, a camera mapping function may be determined. For example, during a camera calibration process, the anchor disks in the segmentation mask may be identified and their positions in image coordinates are calculated and compared with their known coordinates in physical units to obtain the camera mapping function. In the case that a pinhole model is used, the camera mapping function takes the form of

$$\{ \begin{matrix}{X}_{image} = {k}_{x} ( {x}_{world} - {x}_{0} ) \\ {Y}_{image} = {k}_{y} ( {y}_{world} - {y}_{0} )\end{matrix} ,$$

where kₓ and k_{y} are the magnification ratios in both directions, while x₀ and y₀ are the origins of the coordinate system with respect to which the objects are specified in the 3D rendering engine.

At 416, an object list may be generated based on the initial parameters (e.g., the defined object parameters and the randomized visual parameters). For example, the object list may include shape types for the objects in the synthetic image. The object list may also include the positions and dimensions of the objects in physical units.

At 418, the object list may be updated with the camera mapping function. The updated object list may include the shape types. The position and dimensions of the objects may be converted to pixels based on the camera mapping function.

At 420, a second camera pass may be initiated. A random focal length and a random aperture area may be selected. At 422, an image may be rendered using the random focal length and the random aperture area. At 424, random camera effects may be added to the rendered image. For example, random motion blur and random noise may be added to the image. At 426, the synthetic image may be output.

At 428, the object list, segmentation mask and synthetic image may be used to train the ML model.

FIG. 5 illustrates an exploded view of a simulated object for use in ML model-based object detection, according to an example. A simulated object 530 may be generated from a number of simulated subcomponents. In this example, the simulated object 530 is a shipping package (e.g., a cardboard box).

The simulated object 530 may be formed from a number of simulated subcomponents. In some examples, a computer aided design (CAD) model may be used to generate the simulated object 530. In some examples, the simulated object 530 may be formed from a number of subcomponents in a 3D rendering engine.

In this example, the subcomponents may be modeled as rectangular plates to mimic a shipping package. Dimensions of the subcomponents may be randomized to add visual variety to the simulated object 530.

In this example, the subcomponents include a first top flap 532-1, a second top flap 532-2, a label 534, a first side flap 536-1, a second side flap 536-2, a third side flap 536-3, a fourth side flap 536-4, a first side plate 538-1, a second side plate 538-2, and a bottom flap 540.

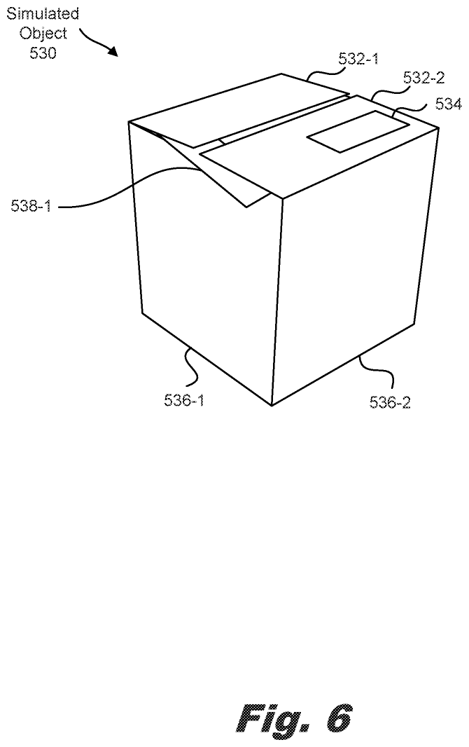

In some examples, multiple synthetic images of the simulated object 530 may be generated based on randomized visual parameters. In some examples, the simulated object 530 may be placed at random 3D positions over the background image, facing the camera lens but rotated by arbitrary angles. An example of the assembled cardboard box is shown in FIG. 6.

To simulate different types of defects, the relative positions between the individual parts of the simulated object 530 may also be randomly varied to help the ML model learn different representations of the simulated object 530.

In some examples, surface texture images may be collected from the actual product photos as cropped patches. For each subcomponent of the simulated object 530, the corresponding texture image may be selected, then randomly scaled, flipped, and rotated arbitrarily before appending to the object surface.

Additional randomized visual parameters used to generate a synthetic image of the simulated object 530 may include lighting, shadows, camera settings, motion and noise. These randomized visual parameters may be implemented as described above.

In some examples, an ML model may be trained to detect the simulated object 530 based on the synthetic images and annotations. For example, the outputs of rendering the synthetic image may include the synthetic image, an instance-wise segmentation mask, and a list of part types, positions, and dimensions in physical units for each rendered part object. In this example, there is a total of 5 different types of objects: Top Flap, Bottom Flap, Label, Side Flap, and Side Plate.

To obtain training targets for each subcomponent of the simulated object 530, the segmentation mask may be compressed by Run-length encoding (RLE) or polygon approximation. The anchor points in the segmentation mask may be identified and their positions in image coordinates may be calculated and compared with their coordinates in physical units to obtain the camera mapping function. Then, bounding boxes for the subcomponents may be calculated after converting the positions and dimensions into image coordinates in pixels using the calibrated camera mapping function.

In some examples, the ML model may be trained with a number (e.g., 1,000) synthetic images and corresponding annotations. In this example, the target objects include “Label”, “Top Flap”, “Bottom Flap”, “Side Flap” and “Side Plate.”

The trained network can be applied to real-world images to identify different parts of the product present in the images. In some examples, the identified parts will be passed to a post-processing module to detect defects. In the example of a shipping package, defects may include no-pattern-found defects, side glue, wrong color, dented surface, large gap, label alignment, and side skew. The described examples are robust to various conditions, and avoid using manual annotation of datasets. The described examples can be deployed on industry production lines with a regular camera (e.g., RGB camera) for defect detection and quality control.

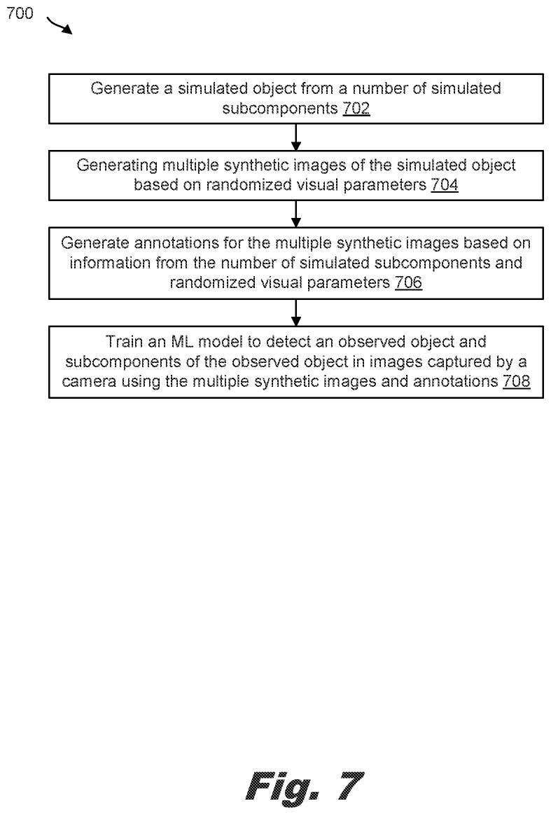

FIG. 7 is a flow diagram illustrating a method 700 for ML model-based object detection, according to an example. In some examples, the method 700 may be performed by a processor, such as the processor 102 of FIG. 1.

At 702, a simulated object may be generated from a number of simulated subcomponents. For example, the subcomponents may include a number of geometric shapes that are arranged to form a simulated object. In an example, the simulated object may include a shipping package and the simulated subcomponents may include components (e.g., label, top flap, bottom flap, side flap, and side plate) of the shipping package.

At 704, multiple synthetic images of the simulated object may be generated based on randomized visual parameters. For example, dimensions and orientation of the simulated object may be randomly adjusted. Furthermore, the background, lighting, shadows, camera settings, motion and noise may be randomly determined for each synthetic image.

At 706, annotations for the multiple synthetic images may be generated based on information from the number of simulated subcomponents and randomized visual parameters. For example, an object type, segmentation mask, and bounding box may be determined for each object in the multiple synthetic images. The annotations for the multiple synthetic images may include identifying a subcomponent of the simulated object based on a part type. For example, in the case of a shipping package, the part types included in the annotations may include label, top flap, bottom flap, side flap, and side plate.

At 708, an ML model may be trained to detect an observed object and subcomponents of the observed object in images captured by a camera using the multiple synthetic images and annotations. For example, a number of synthetic images and their annotations may be fed into the ML model to train the ML model to recognize an observed object and the subcomponents of the observed object.

Upon being trained, the ML model may be run to detect the observed object and subcomponents in an image captured by a camera. For example, in the case of the shipping package, the ML model may receive an image captured by a camera. The ML model may identify the presence of the shipping package and various parts of the shipping package (e.g., label, top flap, bottom flap, side flap, and side plate) in the image.

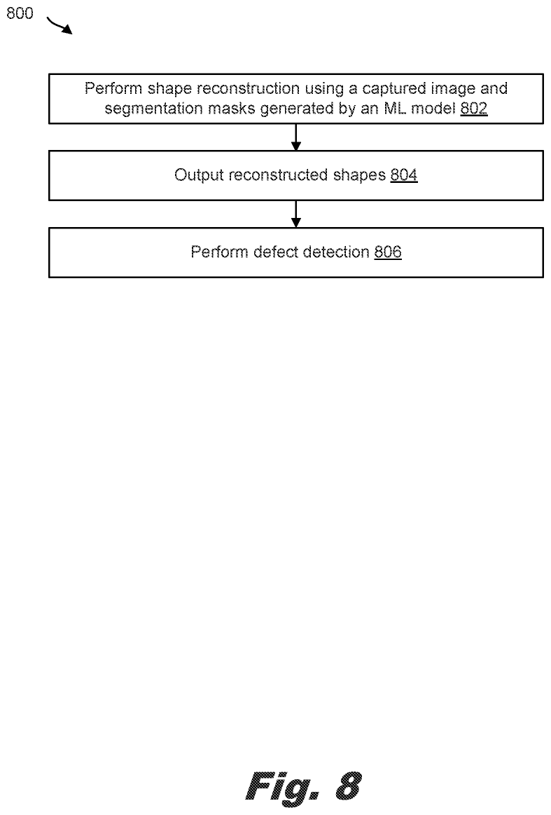

FIG. 8 is a flow diagram illustrating a method 800 for defect detection using the results of ML model-based object detection, according to an example. In some examples, the method 800 may be performed by a processor, such as the processor 102 of FIG. 1.

At 802, shape reconstruction may be performed using a captured image and the segmentations masks generated by an ML model. In some examples, the segmentation masks may be generated as described above. A goal of shape reconstruction is to simplify the contours of the subcomponents in the image to a geometric shape. For example, in the case of a shipping package, the contour of the shipping package components (e.g., label, top flap, bottom flap, side flap, and side plate) may be converted to a quadrilateral.

At 804, the reconstructed shapes may be output. At 806, defect detection may be performed using the captured image, the segmentations masks and the reconstructed shapes. In some examples, a defect in the observed object may be detected based on the detected subcomponents. A goal of the defect detection is to detect if the input image contains certain defects. In the case of a shipping package, the defects may include no-pattern-found, side glue, wrong color, dent surface, large gap, label alignment, and side skew. The processor may compare the relationship of the detected subcomponents to each other to determine whether a defect is present.

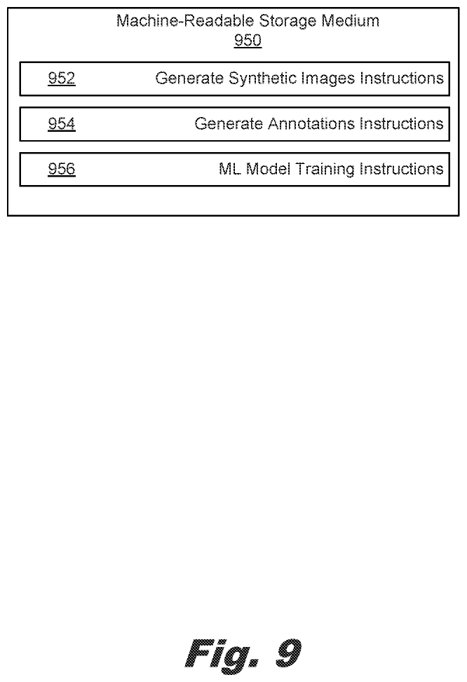

FIG. 9 depicts a non-transitory machine-readable storage medium 950 for generating synthetic images and annotations, according to an example. To achieve its desired functionality, an electronic device 100 includes various hardware components. Specifically, an electronic device includes a processor and a machine-readable storage medium 950. The machine-readable storage medium 950 is communicatively coupled to the processor. The machine-readable storage medium 950 includes a number of instructions 952, 954, 956 for performing a designated function. The machine-readable storage medium 950 causes the processor to execute the designated function of the instructions 952, 954, 956. The machine-readable storage medium 950 can store data, programs, instructions, or any other machine-readable data that can be utilized to operate the electronic device 100. Machine-readable storage medium 950 can store computer readable instructions that the processor of the electronic device 100 can process or execute. The machine-readable storage medium 950 can be an electronic, magnetic, optical, or other physical storage device that contains or stores executable instructions. Machine-readable storage medium 950 may be, for example, Random Access Memory (RAM), an Electrically Erasable Programmable Read-Only Memory (EEPROM), a storage device, an optical disc, etc. The machine-readable storage medium 950 may be a non-transitory machine-readable storage medium 950, where the term “non-transitory” does not encompass transitory propagating signals.

Referring to FIG. 9, generate synthetic images instructions 952, when executed by the processor, may cause the processor to generate multiple synthetic images of multiple objects based on shape types of the multiple objects and randomized parameters applied to the multiple objects. Generate annotations instructions 954, when executed by the processor, may cause the processor to generate annotations for the multiple objects in the multiple synthetic images based on the shape types and the randomized parameters. ML model training instructions 956 when executed by the processor, may cause the processor to train an ML model for detecting the multiple objects using the multiple synthetic images and annotations.

What is claimed is:

1. A computing device, comprising:
a processor; and
a memory communicatively coupled to the processor and storing executable instructions that when executed cause the processor to:
generate multiple synthetic images of an object based on defined object parameters and randomized visual parameters;
generate annotations of the object in multiple synthetic images based on the defined object parameters and the randomized visual parameters; and
train a machine-learning (ML) model for detecting the object using the multiple synthetic images and annotations.

2. The computing device of claim 1, wherein the object comprises a geometric shape.

3. The computing device of claim 1, wherein the randomized visual parameters comprise lighting, object pose, object orientation and background image.

4. The computing device of claim 1, wherein the multiple synthetic images comprise photorealistic images generated by a 3D rendering engine.

5. The computing device of claim 1, wherein the defined object parameters define an object type.

6. A non-transitory computer-readable storage medium comprising instructions executable by a processor to:
generate multiple synthetic images of multiple objects based on shape types of the multiple objects and randomized parameters applied to the multiple objects;
generate annotations for the multiple objects in the multiple synthetic images based on the shape types and the randomized parameters; and
train a machine-learning (ML) model for detecting the multiple objects using the multiple synthetic images and annotations.

7. The non-transitory computer-readable storage medium of claim 6, wherein the instructions to generate the multiple synthetic images comprise instructions executable by the processor to:
add randomized out-of-focus effects of a camera lens to the synthetic images; and
simulate motion blurring in the synthetic images, wherein each of the synthetic images to include different randomized motion blurring.

8. The non-transitory computer-readable storage medium of claim 6, wherein the instructions to generate the multiple synthetic images comprise instructions executable by the processor to:
simulate shadows cast on the multiple objects in the synthetic images, wherein each of the synthetic images to include randomized shadows cast on the multiple objects.

9. The non-transitory computer-readable storage medium of claim 6, wherein the instructions to generate the multiple synthetic images comprise instructions executable by the processor to:
add noise to the synthetic images, wherein each of the synthetic images to include a randomized type of noise.

10. The non-transitory computer-readable storage medium of claim 6, wherein the instructions to generate the annotations comprise instructions executable by the processor to:
record the shape type for each of the multiple objects in the multiple synthetic images;
determine a bounding box for each of the multiple objects in each of the multiple synthetic images; and
generate a segmentation mask for each of the multiple objects in each of the multiple synthetic images.

11. A method, comprising:
generating a simulated object from a number of simulated subcomponents;
generating multiple synthetic images of the simulated object based on randomized visual parameters;
generating annotations for the multiple synthetic images based on information from the number of simulated subcomponents and randomized visual parameters; and
training a machine-learning (ML) model to detect an observed object and subcomponents of the observed object in images captured by a camera using the multiple synthetic images and annotations.

12. The method of claim 11, wherein the simulated object comprises a shipping package and the simulated subcomponents comprise components of the shipping package.

13. The method of claim 11, wherein generating the annotations for the multiple synthetic images comprises identifying a subcomponent of the simulated object based on a part type.

14. The method of claim 11, further comprising running the ML model to detect the observed object and subcomponents in an image captured by a camera.

15. The method of claim 14, further comprising detecting a defect in the observed object based on the detected subcomponents.
